(19) United States
(12) Patent Application Publication
(10) Pub. No.: US 2014/0148922 A1
(43) Pub. Date: May 29, 2014

(54) CONTROL SYSTEM, ABNORMALITY DIAGNOSIS METHOD OF CONTROL SYSTEM, AND COMPUTER-READABLE RECORDING MEDIUM HAVING STORED THEREIN ABNORMALITY DIAGNOSIS PROGRAM OF CONTROL SYSTEM

(71) Applicant: FUJITSU LIMITED, Kawasaki-shi (JP)

(72) Inventor: Tsuyoshi NAKAGAMI, Kahoku (JP)

(73) Assignee: FUJITSU LIMITED, Kawasaki-shi (JP)

(21) Appl. No.: 14/062,938

(22) Filed: Oct. 25, 2013

(30) Foreign Application Priority Data
Nov. 27, 2012 (JP) 2012-258254

(51) Int. Cl. G05B 23/02

(52) U.S. Cl. CPC G05B 23/02
USPC 700/9

(57) ABSTRACT

A control system including at least two controllers configured to serve as initiators to control a control target device. The control system includes a confirmation unit configured to operate one of the two controllers as an initiator and the other controller as a target to confirm statuses of the two controllers, and a validation unit configured to operate an abnormal controller which is confirmed by the confirmation unit as a target and a normal controller as an initiator and performs a data access process on the target to validate a function of the abnormal controller.

### CROSS-REFERENCE TO RELATED APPLICATIONS

This application is based upon and claims the benefit of priority of the prior Japanese Patent Application No. 2012-258254, filed on Nov. 27, 2012, the entire contents of which are incorporated herein by reference.

### FIELD

The embodiments discussed herein are directed to a control system, an abnormality diagnosis method of a control system, and a computer-readable recording medium having stored therein abnormality diagnosis program of a control system.

### BACKGROUND

There is a data storage system which includes a plurality of input/output controllers (IOCs) having a function as initiators that gives a command to a plurality of storage devices. The IOC including such a data storage system is also referred to as a serial attached small computer system interface controller (SAS controller). A data storage system having a function that, if an abnormality of any of IOCs is detected, separates the IOC from which the abnormality is detected is known.

Here, the abnormality of the IOC which is recognized by the data storage system is as follows:

(1) when the IOC reports an abnormal status as a SAS controller,

(2) when the IOC does not response,

(3) when an error regarding a SAS path occurs while accessing the plurality of storage devices which are controlled by the IOC, and

(4) when an abnormality of data as a storage system such as misalignment of a data integrity field is detected.

When the above-mentioned abnormality is detected by the data storage system, it is difficult to discriminate whether the abnormality occurs due to an error in a hardware of the IOC, or an abnormal operation of a farm of the IOC, or other factors than the IOC.

For example, it is known that when the abnormality of the IOC is detected, a chip of the IOC is reset. After resetting the chip, when the IOC normally operates, the data storage system determines that the detected abnormality is not caused by the error in the hardware of the IOC and continuously uses the IOC. In contrast, after resetting the chip, when the IOC does not normally operate or an abnormality of the IOC is detected again, the data storage system separates the IOC from the system.
PATENT LITERATURE 1: Japanese National Publication of International Patent Application No. 2008-545195
PATENT LITERATURE 2: Japanese National Publication of International Patent Application No. 2009-540436

However, in the technique of the related art, when the abnormality detected by the data storage system is caused by a hardware error of the IOC, the abnormality may be generated again after resetting the chip. Further, regardless that the abnormality detected by the data storage system is caused by a reason other than the IOC, when the abnormality of the IOC is detected again after resetting the chip, the IOC is separated regardless of the abnormality in the IOC. Further, even when the abnormality detected by the data storage system is generated by a partial error of the hardware of the IOC, the whole IOC is undesirably separated as the abnormal portion.

### SUMMARY

A control system including at least two controllers configured to serve as initiators to control a control target device, the control system including: a confirmation unit configured to operate one of the two controllers as an initiator and the other controller as a target to confirm statuses of the two controllers; and a validation unit configured to operate an abnormal controller which is confirmed by the confirmation unit as a target and a normal controller as an initiator and performs a data access process on the target to validate a function of the abnormal controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a functional configuration of a storage system as an example of an embodiment;

FIGS. 2A and 2B are diagrams illustrating a validation method of an abnormal portion in a storage system as an example of an embodiment;

FIG. 3 is a flowchart illustrating an abnormality diagnosis processing in the storage system as an example of an embodiment;

FIG. 4 is a flowchart illustrating an abnormality diagnosis processing in the storage system as an example of an embodiment;

FIG. 5 is a diagram schematically illustrating a functional configuration of a storage system as a first modification example of an embodiment;

FIG. 6 is a flowchart illustrating an abnormality diagnosis processing in the storage system as the first modification example of an embodiment;

FIG. 7 is a diagram schematically illustrating a functional configuration of a storage system as a second modification example of an embodiment; and

FIG. 8 is a flowchart illustrating an abnormality diagnosis processing in the storage system as the second modification example of an embodiment.

### DESCRIPTION OF EMBODIMENTS

### [A] Embodiment

Hereinafter, embodiments of a control system, an abnormality diagnosis method of the control system, and a computer-readable recording medium having stored therein abnormality diagnosis program of the control system will be described with reference to drawings. However, the embodiments described below are only illustrative but do not intend to exclude various modification examples or technologies which are not described in the embodiment. That is, the embodiments may be modified in various manners (combination of embodiments and modification examples) without departing from a gist of the invention.

Further, each drawing does not intend to include only components described in the drawings but may further include other functions.

[A-1] System Configuration

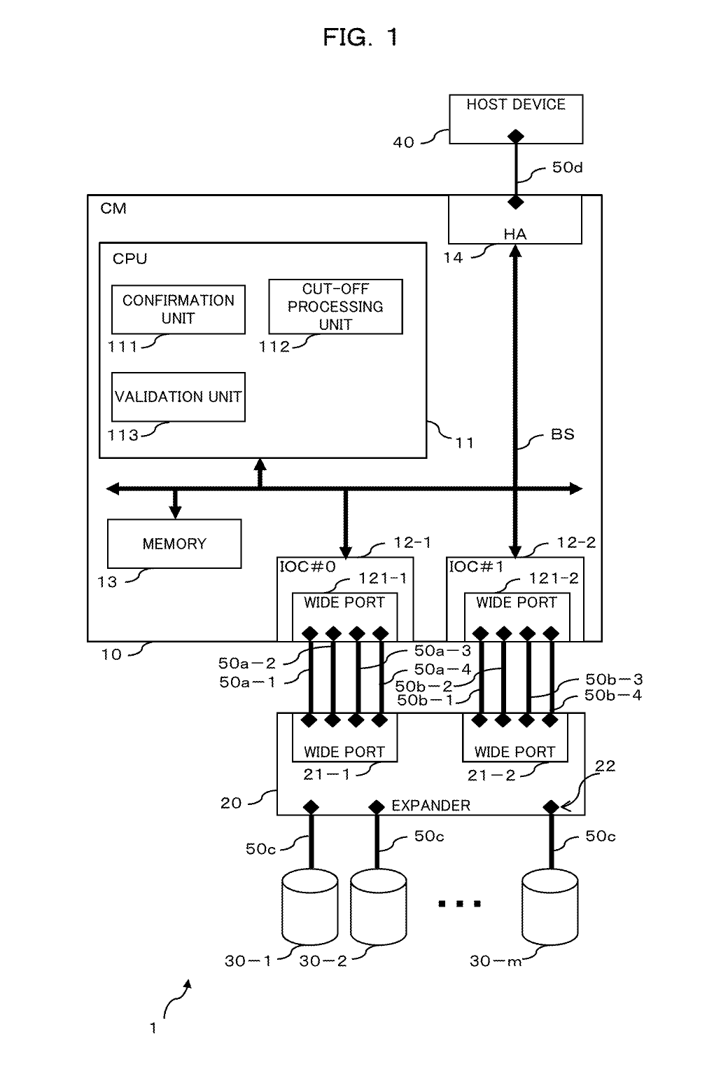

FIG. 1 is a diagram schematically illustrating a functional configuration of a storage system as an example of an embodiment.

A control system (storage system) 1 according to the embodiment, as illustrated in FIG. 1, includes a control module (CM) 10, an expander 20, a plurality of storage devices 30-1 to 30-m (m is an integer of 1 or higher), and an upper device (host device) 40. The storage system 1 provides a storage area for the host device 40.

Hereinafter, as a reference numeral indicating the storage device, when it is required to specify one of the plurality of storage devices, reference numerals 30-1 to 30-m are used. But, when any of storage devices is indicated, a reference numeral 30 is used.

The CM 10 and the expander 20 are connected through phys 50a-1 to 50a-4, and 50b-1 to 50b-4 as physical wiring lines (physical links). Further, the expander 20 and the storage device 30 are connected to each other through a phy 50c. Further, the CM 10 and the host device 40 are connected through a phy 50d.

The host device 40 is, for example, a computer (information processing device) having a function as a server. Even though one host device 40 is provided in an example illustrated in FIG. 1, for example, two or more host devices 40 may be provided.

The expander 20 relays the CM 10 and the storage device 30 and transmits data based on an input/output (I/O) of the host device. In other words, the CM 10 accesses the storage device 30 provided in the storage system 1 through the expander 20.

The expander 20, as illustrated in FIG. 1, includes wide ports 21-1 and 21-2 and a storage port 22. The storage port 22 includes m ports and the storage devices 30 are connected to the ports one to one.

The wide port 21-1 is a port which is connected to a wide port 121-1 of the CM 10, which will be described below, through a plurality (four in this embodiment) of phys 50a-1 to 50a-4. Hereinafter, as reference numerals which indicate phys connecting between the wide ports 121-1 and 21-1, when it is required to specify one of the plurality of phys, reference numerals 50a-1 to 50a-4 are used, but when an arbitrary phy is indicated, a reference numeral 50a is used.

The wide port 21-2 is a port which is connected to a wide port 121-2 of the CM 10, which will be described below, through a plurality (four in this embodiment) of phys 50b-1 to 50b-4. Hereinafter, as reference numerals which indicate phys connecting between the wide ports 121-2 and 21-2, when it is required to specify one of the plurality of phys, reference numerals 50b-1 to 50b-4 are used, but when an arbitrary phy is indicated, a reference numeral 50b is used.

In other words, in the wide ports 21-1 and 21-2, the same number (four in this embodiment) of the ports as the number of the phys 50a and 50b are provided and phys 50a and 50b are connected to the ports one to one. That is, the wide ports 21-1 and 21-2 are provided so as to correspond to the phys 50a and 50b. Further, the same number of wide ports 21 as the number of IOC 12-1 and IOC 12-2 of the CM 10, which will be described below, is provided (two in the embodiment).

The storage device 30 is a storing device which stores data to be readable and for example, is a hard disk drive (HDD). In an example illustrated in FIG. 1, m storage devices 30 are provided and these storage devices 30 have the same configuration.

The CM 10 includes a central processing unit (CPU) 11, an IOC 12-1, an IOC 12-2, a memory 13, and a host adapter (HA) 14.

Hereinafter, the IOC 12-1 is referred to as an IOC #0 and the IOC 12-2 is referred to as an IOC #1 in some cases.

Further, hereinafter, when a specific IOC is indicated, the IOC is denoted as the “IOC 12-1”, the “IOC #0”, the “IOC 12-2”, or the “IOC #1”. However, when an arbitrary server device is indicated, the IOC is denoted as an “IOC 12”.

The CPU 11, the IOC 12, the memory 13, and the HA 14 are connected through a peripheral component interconnect bus (PCI bus) BS so as to be communicated with each other.

The HA 14 has a function that connects a local device (CM 10) and the host device 40 so as to be communicated with each other.

The IOC #0 and the IOC #1 include wide ports 121-1 and 121-2, respectively.

The wide port 121-1 is a port which is connected to the wide port 21-1 of the expander 20 through the phy 50a.

The wide port 121-2 is a port which is connected to the wide port 21-2 of the expander 20 through the phy 50b.

In other words, in the wide ports 121-1 and 121-2, the same number (four in this embodiment) of the ports as the number of the phys 50a and 50b are provided and phys 50a and 50b are connected to the ports one to one. That is, the wide ports 121-1 and 121-2 are provided so as to correspond to the phys 50a and 50b.

In the embodiment, the IOC 12 has a function as an initiator and a function as a target.

Here, the function as an initiator is a function that the IOC 12 gives a command to another device (for example, the storage device 30 or another IOC 12). Further, the function as a target is a function that the IOC 12 receives a command from another device (for example, another IOC 12).

When there is an access request from the host device 40 to the storage device 30, the IOC #0 functions as an initiator and gives a command to read/write data to the storage device 30 through the phy 50a, the expander 20 and the phy 50c. Similarly, when there is an access request from the host device 40 to the storage device 30, the IOC #1 functions as an initiator and gives a command to read/write data to the storage device 30 through the phy 50b, the expander 20 and the phy 50c.

Further, by functions as a confirmation unit 111 and a validation unit 113 of the CPU 11 which will be described below, the IOC #0 issues an access command to access the memory 13 to the IOC #1 through the phy 50a, the expander 20, and the phy 50b. In this case, the IOC #0 functions as an initiator and the IOC #1 functions as a target. Similarly, by functions as the confirmation unit 111 and the validation unit 113 of the CPU 11 which will be described below, the IOC #1 issues an access command to access the memory 13 to the IOC #0 through the phy 50b, the expander 20, and the phy 50a. In this case, the IOC #1 functions as an initiator and the IOC #0 functions as a target.

Further, even though two IOCs 12 are provided in an example illustrated in FIG. 1, the embodiment is not limited thereto and three or more IOCs 12 may be provided.

The memory 13 is a recording device including a read only memory (ROM) and a random access memory (RAM). An operating system (OS), a software program related to an abnormality diagnosis of a control system (an abnormality diagnosis program of the control system) or data for the program is written in the ROM of the memory 13. The software program on the memory 13 is appropriately read in the CPU 11 so as to be executed. Further, the RAM of the memory 13 is used as a primary recording memory or a working memory.

In an example of the embodiment, the memory 13 includes a work area which is not illustrated and when the abnormality diagnosis of the IOC 12 is performed, the IOC 12 reads out data in the work area.

The CPU 11 is a processing device which performs various control or operation and executes OS or a program stored in the memory 13 to implement various functions. That is, the CPU 11, as illustrated in FIG. 1, functions as the confirmation unit 111, a cut-off processing unit 112, and the validation unit 113.

Therefore, the CPU 11 executes the abnormality diagnosis program of the control system to function as the confirmation unit 111, the cut-off processing unit 112, and the validation unit 113.

Further, a program (the abnormality diagnosis program of the control system) which implements the function as the confirmation unit 111, the cut-off processing unit 112, and the validation unit 113 is provided so as to be recorded in a computer-readable recording medium such as a flexible disk, a CD (a CD-ROM, a CD-R, or a CD-RW), a DVD (a DVD-ROM, a DVD-RAM, a DVD-R, a DVD+R, a DVD-RW, a DVD+RW, or an HD DVD), a Blu-ray Disc, a magnetic disk, an optical disk, or a magneto-optical disk. Therefore, the computer reads out the program from the recording medium and transmits the program to an internal recording device or an external recording device so as to be recorded therein. Alternatively, the program is recorded in the recording device (recording medium) such as a magnetic disk, an optical disk, or a magneto-optical disk and provided to the computer from the recording device through the communication path.

When the function as the confirmation unit 111, the cut-off processing unit 112, and the validation unit 113 is implemented, the program stored in the internal recording device (the memory 13 in the embodiment) is executed by a microprocessor (a CPU 11 in the embodiment) of the computer. In this case, the program recorded in the recording medium may be read out by the computer to be executed.

Further, in the embodiment, the computer is a concept including a hardware and an OS and refers to a hardware which operates under the control of the OS. When the OS is not necessary and the application program operates the hardware by itself, the hardware itself corresponds to the computer. The hardware at least includes a microprocessor such as the CPU 11 and a unit which reads out a computer program recorded in the recording medium. In the embodiment, the CM 10 and the host device 40 have a function as a computer.

The confirmation unit 111 causes one of the IOCs 12 to operate as an initiator and another IOC 12 to operate as a target to confirm whether the IOCs 12 normally operate. The confirmation of the operation of the IOC 12 by the confirmation unit 111 uses a known method and the detailed description will be omitted.

Here, the abnormality of the IOC 12 which is recognized by the confirmation unit 111 is as follows:

(1) when the IOC reports an abnormal status as a SAS controller,

(2) when the IOC does not response,

(3) when an error regarding a SAS path occurs while accessing the plurality of storage devices which are controlled by the IOC, and

(4) when an abnormality of data as a storage system such as misalignment of a data integrity field is detected.

The cut-off processing unit 112 temporarily separates the IOC 12 which is confirmed by the confirmation unit 111 to be abnormal from the storage system 1. Further, the cut-off processing unit 112 separates the IOC 12 or the phys 50a and 50b indicated by the validation unit 113. The cut-off processing is implemented by various known methods and detailed description thereof will be omitted.

The validation unit 113 validates whether the abnormality of the IOC 12 which is confirmed by the confirmation unit 111 is an abnormality of the IOC 12 itself or an abnormality of any of phys 50a (or 50b) connected to the IOC 12.

[A-2] Example of Validation Method of Abnormal Portion

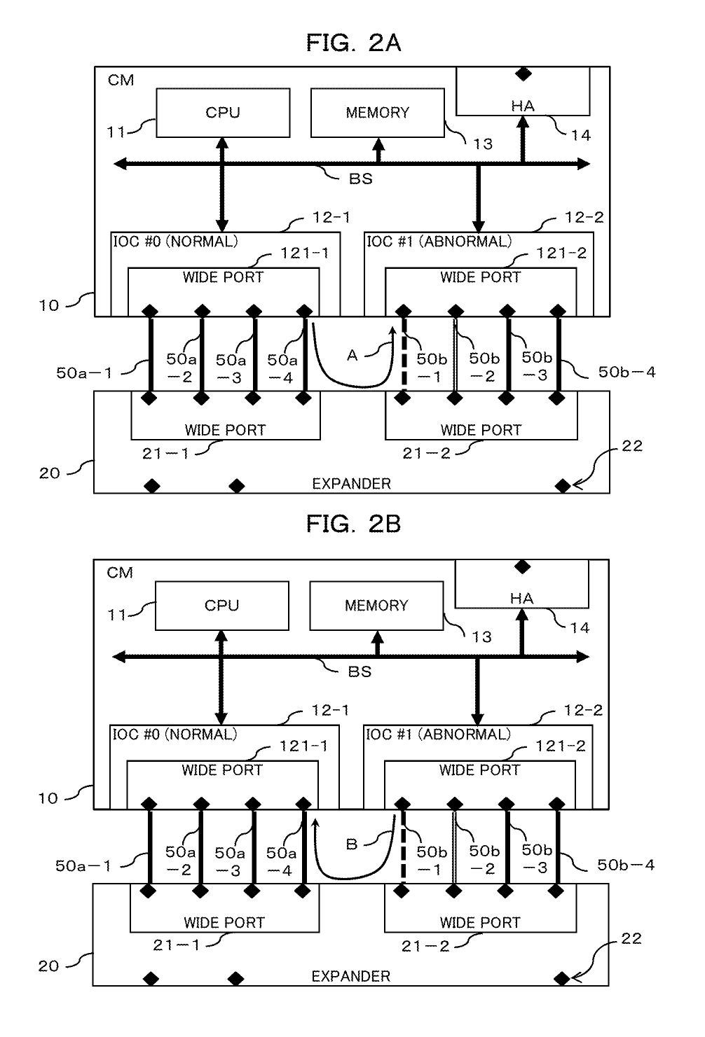

FIGS. 2A and 2B are diagrams illustrating a validation method of an abnormal portion in a storage system as an example of an embodiment. FIG. 2A is a diagram illustrating a validation processing of a common function of an abnormal IOC and FIG. 2B is a diagram illustrating a validation processing of a function as an initiator of the abnormal IOC.

In FIGS. 2A and 2B, for convenience sake, only the CM 10, the expander 20, and the phys 50a and 50b of the storage system 1 are illustrated and other components are omitted.

In FIGS. 2A and 2B, an example in which the IOC #0 is normal and the abnormality of the IOC #1 is confirmed by the confirmation unit 111 is illustrated. In this example, it is considered that the abnormality of the IOC #1 is caused by the abnormality of a common function of the function as the initiator and the function as the target of the phy 50b-1 illustrated by the broken line and the abnormality of the function as the initiator of the phy 50b-2 illustrated by the double line.

First, the confirmation unit 111 confirms the abnormality of the IOC #1.

The cut-off processing unit 112 temporarily separates the IOC #1 which is confirmed by the confirmation unit 111 to be abnormal from the storage system 1.

The validation unit 113 validates whether the abnormality of the IOC #1 which is confirmed by the confirmation unit 111 is an abnormality of the IOC #1 itself or an abnormality of any of phys 50b connected to the IOC #1. The validation unit 113, first, as illustrated in FIG. 2A, causes the normal IOC #0 to function as the initiator and the abnormal IOC #1 as the target to validate the common function of the abnormal IOC. Thereafter, the validation unit 113, as illustrated in FIG. 2B, causes the abnormal IOC #1 to function as the initiator and the normal IOC #2 as the target to validate the initiator function of the abnormal IOC. In such a validation processing of the common function of the abnormal IOC, the abnormal IOC #1 is functioned as the target so that the common function of the initiator function and the target function of the abnormal IOC #1 is validated. Further, in the validation processing of the initiator function of the abnormal IOC, the abnormal IOC #1 is functioned as the initiator so that the initiator function of the abnormal IOC #1 is validated. As described above, after validating the common function of the initiator function and the target function of the abnormal IOC #1, the initiator function is validated so that the abnormality due to the access from the abnormal IOC #1 is prevented from occurring in the normal IOC #0.

First, as illustrated by an arrow A of FIG. 2A, the validation unit 113 causes the IOC #0 to access the data stored in the work area of the memory 13 with respect to the IOC #1 through any one of the phys 50a, the expander 20, and the phy 50b. That is, the validation unit 113 causes the IOC #0 to function as the initiator and the IOC #1 to function as the target.

Here, as any one of phys 50a, for example, the phy 50a which is not used for the access request to the storage device 30 from the host device 40 is desirably selected. Here, for example, the IOC #0 accesses the memory 13 through the phy 50a-1.

Specifically, the validation unit 113 causes the IOC #0 to access the data stored in the memory 13 with respect to the IOC #1 through the phy 50a-1, the expander 20, and the phy 50b-1. The validation unit 113 performs the data access by sequentially changing the phys 50b-1, 50b-2, 50b-3, and 50b-4 to validate all phys 50b. That is, the validation unit 113 causes the IOC #0 to access the data stored in the memory 13 with respect to the IOC #1 through the phy 50a-1, the expander 20, and the phy 50b-2. Further, the validation unit 113 causes the IOC #0 to access the data stored in the memory 13 with respect to the IOC #1 through the phy 50a-1, the expander 20, and the phy 50b-3. That is, the validation unit 113 causes the IOC #0 to access the data stored in the memory 13 with respect to the IOC #1 through the phy 50a-1, the expander 20, and the phy 50b-4.

As described above, the validation unit 113 causes the IOC #0 to access the data stored in the memory 13 while sequentially changing all (four in an example of the embodiment) phys 50b in the abnormal IOC #1. Further, the order of the phys 50b used when the IOC #0 accesses the memory 13 is not limited to the above-mentioned order, but, for example, the order of phys 50b-4, 50b-3, 50b-2, and 50b-1 may be used.

In the example illustrated in FIG. 2A, since the common function of the phy 50b-1 is abnormal, the IOC #0 may not access the memory 13 through the phy 50b-1. In contrast, since the common function of the phys 50b-2 to 50b-4 is normal, the IOC #0 may access the memory 13 through the phys 50b-2 to 50b-4. The validation unit 113 validates whether the IOC #0 accesses the memory 13 through each of phys 50b, so as to specify the phy 50b-1 which is an abnormal portion of the common function.

When the abnormal phy 50b-1 of the common function is specified, the cut-off processing unit 112 separates the phy 50b-1 from the wide port 21-2 of the expander 20.

Further, when the common function of the IOC #1 itself is abnormal (for example, when the hardware of the IOC #1 is abnormal), the IOC #0 may not access the memory 13 through any of the phys 50b. Accordingly, the validation unit 113 recognizes that all phys 50b are abnormal. The cut-off processing unit 112 separates all phys 50b from the wide port 21-2 of the expander 20.

Next, as illustrated by an arrow B of FIG. 2B, the validation unit 113 causes the IOC #1 to access the data stored in the work area of the memory 13 with respect to the IOC #0 through each of the phys 50b, the expander 20, and any one of the phys 50a. That is, the IOC #1 functions as an initiator and the IOC #0 functions as a target.

Here, similarly to the validation processing of the common portion of the abnormal IOC described above, for example, the IOC #1 accesses the memory 13 through the phy 50a-1.

Specifically, the validation unit 113 causes the IOC #1 to access the data stored in the memory 13 with respect to the IOC #0 through the phy 50b-2, the expander 20, and the phy 50a-1. The validation unit 113 performs the data access by sequentially changing the phys 50b-2, 50b-3, and 50b-4 to validate all phys 50b excluding the phy 50b-1 which is separated in the validation processing on the common portion of the abnormal IOC. That is, the validation unit 113 causes the IOC #1 to access the data stored in the memory 13 with respect to the IOC #0 through the phy 50b-3, the expander 20, and the phy 50a-1. The validation unit 113 causes the IOC #1 to access the data stored in the memory 13 with respect to the IOC #0 through the phy 50b-4, the expander 20, and the phy 50a-1.

As described above, the validation unit 113 causes the IOC #1 to access the data in the memory 13 while sequentially changing all (three in this example) phys 50b in the abnormal IOC #1 side excluding the phy 50b-1 which is separated in the validation processing of the common portion of the abnormal IOC. Further, the order of the phys 50b used when the IOC #1 accesses the memory 13 is not limited to the above-mentioned order, but, for example, the order of phys 50b-4, 50b-3, and 50b-2 may be used.

In the example illustrated in FIG. 2B, since the initiator function of the phy 50b-2 is abnormal, the IOC #1 may not access the memory 13 through the phy 50b-2. In contrast, since the initiator function of the phys 50b-3 and 50b-4 is normal, the IOC #1 may access the memory 13 through the phys 50b-3 and 50b-4. The validation unit 113 validates whether the IOC #1 may access the memory 13 through each phy 50b excluding the phy 50b-1 which is separated in the validation processing of the common portion of the abnormal IOC to specify the abnormal phy 50b-2 of the initiator function.

When the abnormal phy 50b-2 of the initiator function is specified, the cut-off processing unit 112 separates the phy 50b-2 from the wide port 121-2 of the IOC #1.

Further, when the initiator function of the IOC #1 itself is abnormal (for example, when the hardware of the IOC #1 is abnormal), the IOC #0 may not access the memory 13 through any of the phys 50b. Accordingly, the validation unit 113 recognizes that all phys 50b are abnormal. The cut-off processing unit 112 separates all phys 50b from the wide port 121-2 of IOC #1.

By the above-described processing, the abnormal phys 50b-1 and 50b-2 are completely separated and the cut-off processing unit 112 releases the temporal separation of the IOC #1 to be returned to the storage system 1.

Further, when all phys 50b are separated, the cut-off processing unit 112 does not release the temporal separation of the IOC #1.

[A-3] Operation

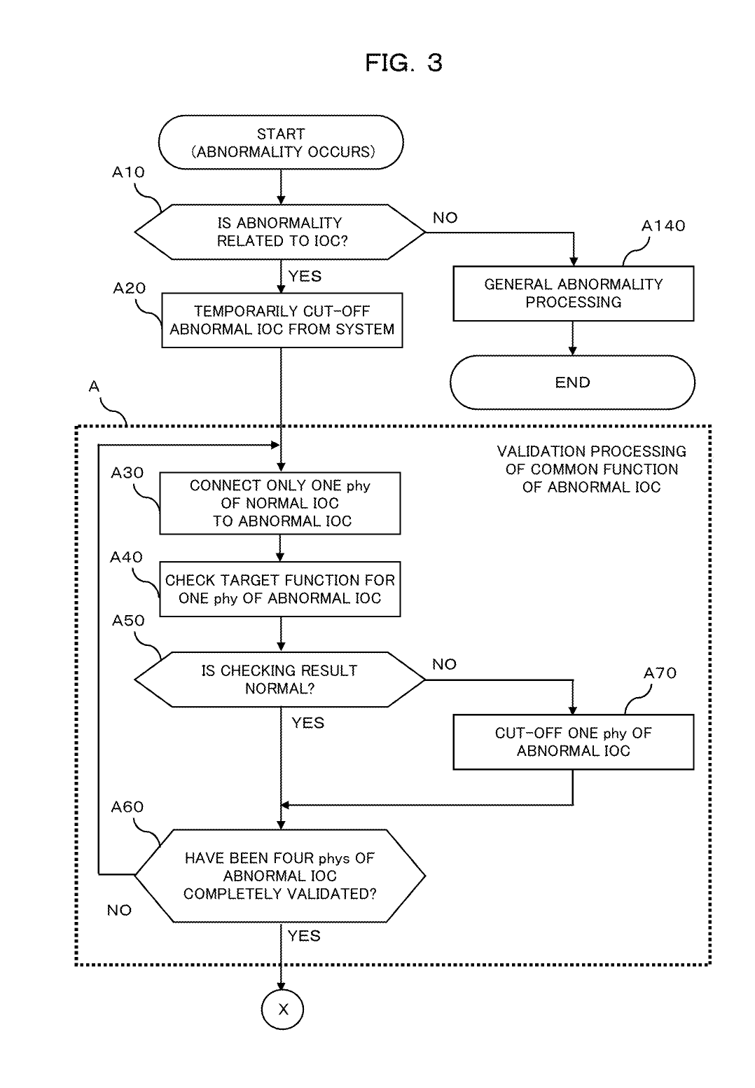

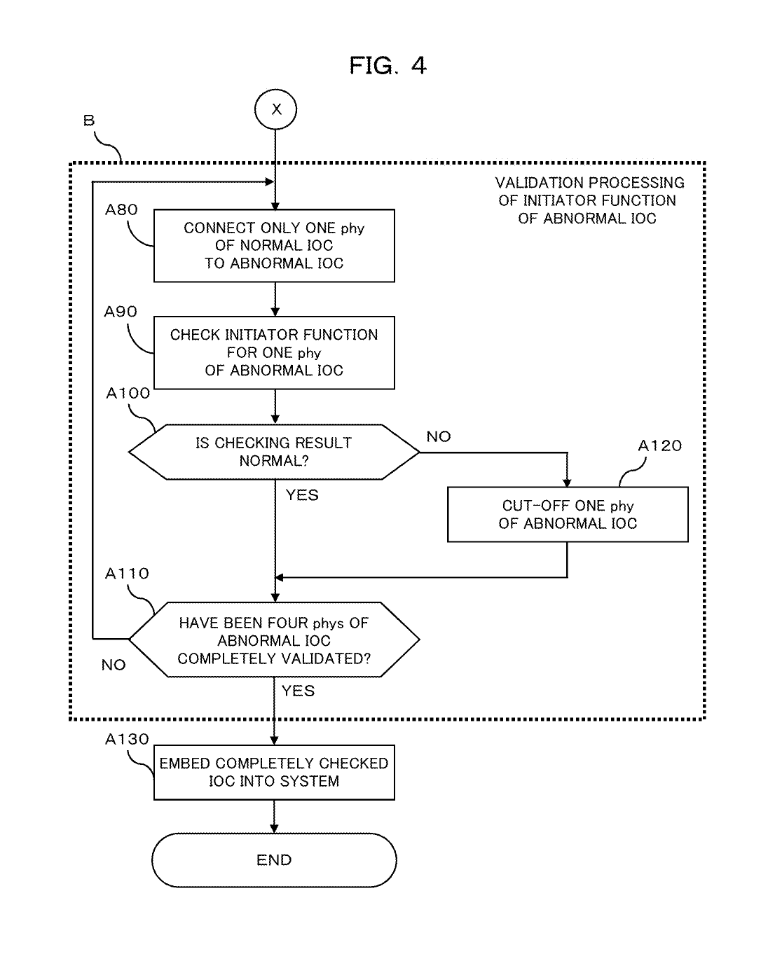

An abnormality diagnosis process in the storage system 1 as an example of the embodiment configured as described above will be described with reference to the flowchart (steps A10 to A140) of FIGS. 3 and 4. FIG. 3 illustrates steps A10 to A70, and A140 and FIG. 4 illustrates steps A80 to A130.

When abnormality occurs in the storage system 1, the confirmation unit 111 confirms whether the generated abnormality is related with the IOC 12 (step A10 of FIG. 3). The determination is implemented, for example, by determining which one of the abnormalities (1) to (4) of the IOC indicates the abnormality, referring to an error log.

When the generated abnormality is related with the IOC 12 (see YES route of step A10 of FIG. 3), the cut-off processing unit 112 temporarily separates the IOC 12 in which the abnormality is generated from the storage system 1 (step A20 of FIG. 3).

The validation unit 113 performs the validation processing A of the common function of the abnormal IOC (steps A30 to A70 of FIG. 3).

The validation unit 113 causes the normal IOC 12 to function as an initiator and the abnormal IOC 12 to function as a target and connects any one of phys (hereinafter, referred to as a phy for validation) in the normal IOC 12 to the abnormal IOC 12 (step A30 of FIG. 3).

The validation unit 113 causes the normal IOC 12 to access the data stored in the work area of the memory 13 with respect to the abnormal IOC 12 through the phy for validation, the expander 20, and one of phys in the abnormal IOC 12. By doing this, the validation unit 113 checks the target function of the phy in the used abnormal IOC 12 (step A40 of FIG. 3).

The validation unit 113 determines whether the check result is normal, that is, whether to access the memory 13 (step A50 of FIG. 3).

When the check result is normal (see Yes route of step A50 of FIG. 3), the validation unit 113 determines whether all phys (four in the embodiment) in the abnormal IOC 12 is completely validated (step A60 of FIG. 3).

In contrast, when the check result is not normal (see No route of step A50 of FIG. 3), the cut-off processing unit 112 commands the expander 20 to separate the abnormal phy (step A70 of FIG. 3) and then proceeds to step A60.

When all phys of the abnormal IOC 12 are not completely validated (see No route of step A60 of FIG. 3), the phy of the abnormal IOC 12 is changed and the processing returns to step A30.

In the meantime, when all phys of the abnormal IOC 12 are completely validated (see Yes route of step A60 of FIG. 3), the validation unit 113 performs a validation processing B of the initiator function of the abnormal IOC (steps A80 to A120 of FIG. 4).

The validation unit 113 causes the abnormal IOC 12 to function as an initiator and the normal IOC 12 to function as a target and connects a phy for validation to the abnormal IOC 12 (step A80 of FIG. 4).

The validation unit 113 causes the abnormal IOC 12 to access the data stored in the work area of the memory 13 with respect to the normal IOC 12 through one of phys in the abnormal IOC 12, the expander 20, and the phy for validation. By doing this, the validation unit 113 checks the initiator function of the phy in the used abnormal IOC 12 (step A90 of FIG. 4).

The validation unit 113 determines whether the check result is normal, that is, whether to access the memory 13 (step A100 of FIG. 4).

When the check result is normal (see Yes route of step A100 of FIG. 4), the validation unit 113 determines whether all phys in the abnormal IOC 12 are completely validated excluding the phy separated in step A70 (step A110 of FIG. 4).

In contrast, when the check result is not normal (see No route of step A100 of FIG. 4), the cut-off processing unit 112 commands the abnormal IOC 12 to separate the abnormal phy (step A120 of FIG. 4) and then proceeds to step A110.

When all phys of the abnormal IOC 12 are not completely validated excluding the phys separated in step A70 (see No route of step A110 of FIG. 4), the phy of the abnormal IOC 12 is changed and the processing returns to step A80.

In contrast, when all phys in the abnormal IOC 12 is validated excepting the phy separated in step A70 (Yes route of step A110 of FIG. 4), the cut-off processing unit 112 releases the temporal separation of the abnormal IOC 12 to be returned to the storage system 1 (step A130 of FIG. 4). Further, when all phys of the abnormal IOC 12 are separated, the cut-off processing unit 112 does not release the temporal separation of the abnormal IOC 12.

As described above, the abnormality diagnosis processing in the storage system 1 is completed.

In the meantime, if the generated abnormality is not related with the IOC 12 (for example, the storage device 30 or the phy 50c is abnormal) (See No route of step A10 of FIG. 3), the CPU 11 or an operator performs the generally abnormality processing (Step A140 of FIG. 3) by an existing method and then abnormality diagnosis processing in the storage system 1 is completed.

[A-4] Effect

As described above, according to the storage system 1 as the example of the embodiment, the IOC 12 in which the abnormality is detected may be efficiently separated from the system.

Further, the cut-off processing unit 112 may separate every abnormal phy and may avoid the separation of the overall IOC 12 in which the abnormality is detected so that a redundant system may be achieved.

Further, the validation unit 113 performs the validation processing of the initiator function after performing the validation processing of the common function of the IOC 12 in which the abnormality is detected so that it is possible to reduce the influence on the normal IOC 12.

Further, the validation unit 113 uses only one phy in the normal IOC 12 for the diagnosis processing so that it is possible to continuously perform the normal operation of the system during the diagnosis processing.

### [B] Modification Example

The disclosed technology is not limited to the embodiment described above and various modification may be made in the invention without departing from the purpose of the embodiment. The configurations or processing of the embodiment may be selected if necessary or appropriately combined.

### [B-1] First Modification Example

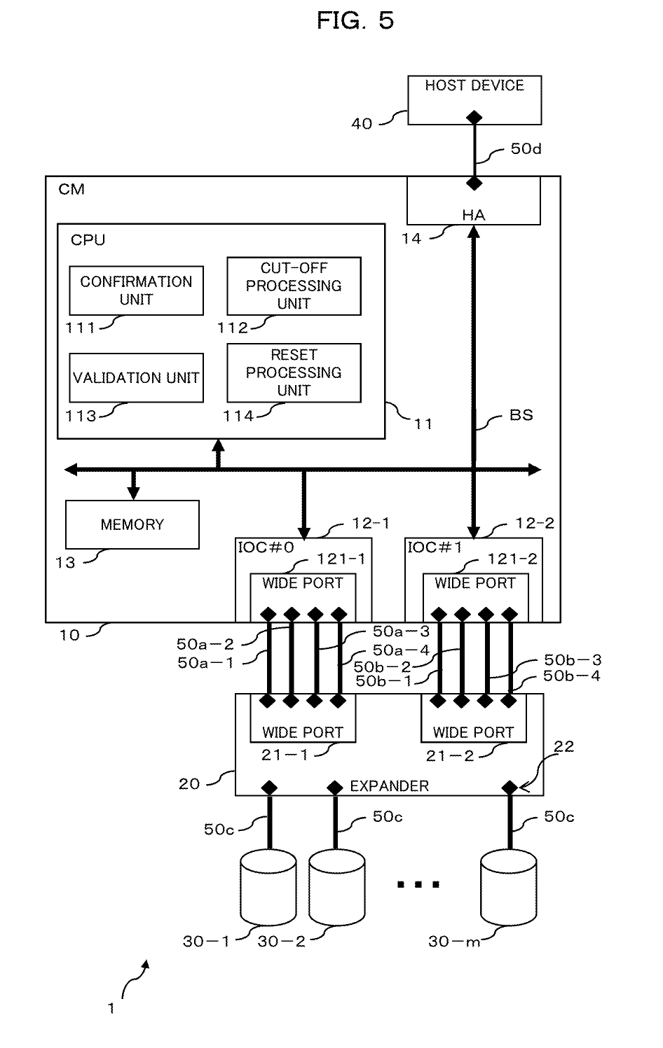

FIG. 5 is a diagram schematically illustrating a functional configuration of a storage system as the first modification example of the embodiment.

Hereinafter, in the drawings, reference numerals same as the previously described reference numerals indicate the same components denoted by the previously described reference numerals so that the description thereof will not be repeated.

In a storage system 1 as the first modification example of the embodiment, as illustrated in FIG. 5, the CPU 11 includes a reset processing unit 114 in addition to the functional configuration of the storage system 1 as the example of the embodiment.

The reset processing unit 114 resets the chip of the IOC 12 in which the abnormality is confirmed. Further, when the confirmation unit 111 confirms an abnormality related to the IOC 12, the reset processing unit 114 determines whether the chip of the IOC 12 in which the abnormality is confirmed has been reset in the past. When the reset has not been performed in the past, the reset processing unit 114 resets the chip. Further, the reset processing unit 114 determines whether the chip was successfully reset, that is, the IOC 12 in which the abnormality is confirmed restarted.

For example, the reset processing unit 114 stores a log concerning whether the chip of the IOC 12 has been reset in the past in the memory 13 and determines whether to perform the reset processing referring to the log. The reset processing unit 114 may delete the log stored in the memory 13 when a predetermined period has elapsed.

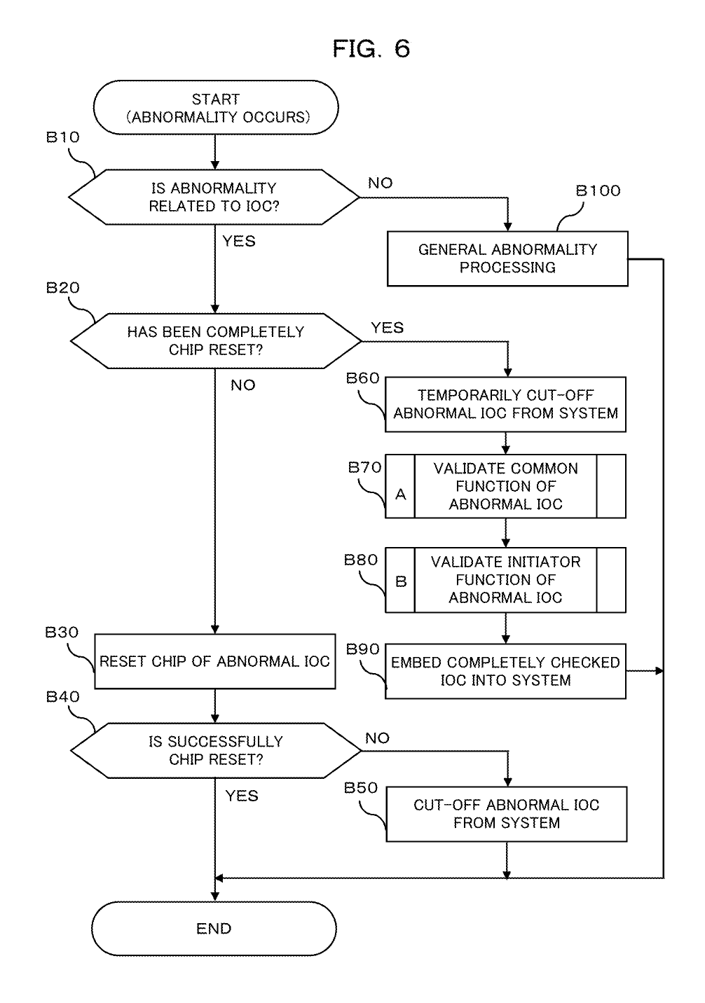

The abnormality diagnosis processing in the storage system 1 as the first modification example of the embodiment configured as described above will be descried with reference to the flowchart illustrated in FIG. 6 (steps B10 to B100).

When abnormality occurs in the storage system 1, the confirmation unit 111 confirms whether the generated abnormality is related with the IOC 12 (step B10). For example, the determination is implemented by determining which one of the abnormalities (1) to (4) of the IOC indicates the abnormality, referring to an error log.

When the generated abnormality is related with the IOC 12 (see Yes route of step B10), the reset processing unit 114 determines whether the chip of the IOC 12 in which the abnormality is generated has been reset in the past (step B20).

When the chip of the IOC 12 in which the abnormality is generated has not been reset in the past (No route of step B20), the reset processing unit 114 resets the chip of the IOC 12 in which the abnormality is generated (step B30).

The reset processing unit 114 determines whether the chip was successfully reset, that is, whether the IOC 12 in which the abnormality is generated, is restarted.

When the chip was successfully reset (see Yes route of step B40), the abnormality diagnosis processing in the storage system 1 is completed.

In contrast, when the chip was not successfully reset (see No route of step B40), the cut-off processing unit 112 separates the IOC 12 in which the abnormality is generated from the storage system 1 (step B50) and completes the abnormality diagnosis processing in the storage system 1.

Further, when the chip of the IOC 12 in which the abnormality is generated has been reset in the past (see Yes route of step B20), the cut-off processing unit 112 temporarily separates the IOC 12 in which the abnormality is generated from the storage system 1 (step B60).

The validation unit 113 performs the validation processing A (see steps A30 to A70 of FIG. 3) of the common function of the abnormal IOC (step B70).

The validation unit 113 performs the validation processing B (see steps A80 to A120 of FIG. 4) of the initiator function of the abnormal IOC (step B80).

The cut-off processing unit 112 releases the temporary separation of the abnormal IOC 12 to be returned to the abnormal IOC 12 to the storage system 1 (step B90) and completes the abnormality diagnosis processing in the storage system 1. Further, when all phys of the abnormal IOC 12 are separated, the cut-off processing unit 112 does not release the temporal separation of the abnormal IOC 12.

In the meantime, when the generated abnormality is not related with the IOC 12 (for example, the storage device 30 or the phy 50c is abnormal) (See No route of step B10), the CPU 11 or an operator performs the generally abnormality processing by an existing method (step B100) and then abnormality diagnosis processing in the storage system 1 is completed.

As described above, according to the storage system 1 as the first modification example of the embodiment, the same operation and effect as the example of the embodiment described above may be obtained and the following effect may be also achieved.

The reset processing unit 114 confirms whether the chip of the IOC 12 has been reset and when the chip has not been reset, the chip of the IOC 12 in which the abnormality is detected is reset before validating the abnormal portion by the validation unit 113 so that it takes less time to perform the abnormality diagnoses processing.

### [B-2] Second Modification Example

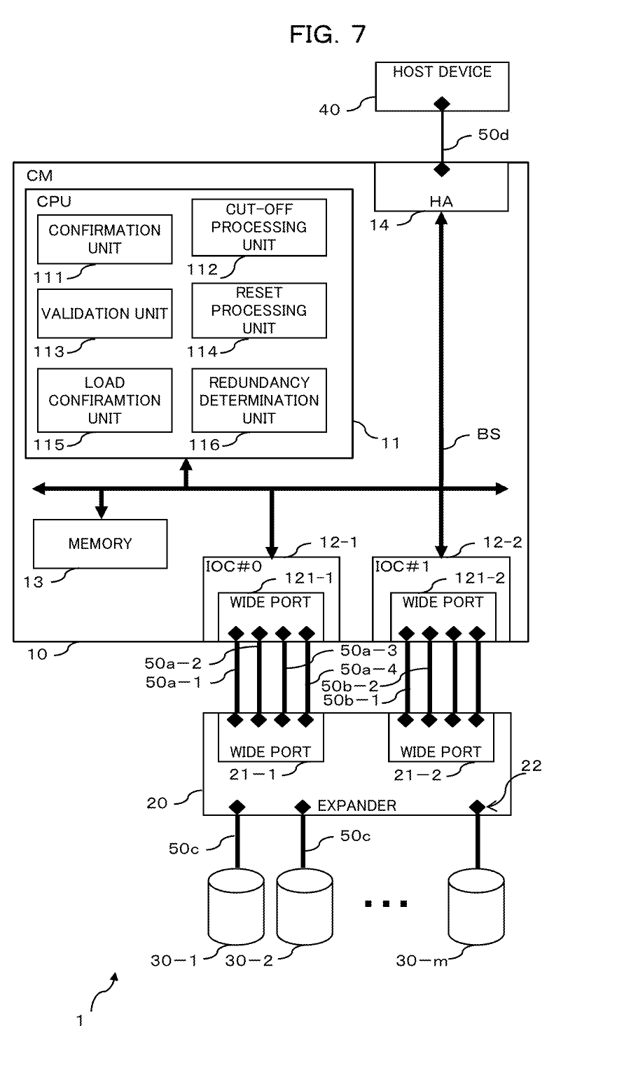

FIG. 7 is a diagram schematically illustrating a functional configuration of a storage system as a second modification example of the embodiment.

Hereinafter, in the drawings, reference numerals same as the previously described reference numerals indicate the same components as the reference numerals so that the description thereof will not be repeated.

In a storage system 1 as the second modification example of the embodiment, as illustrated in FIG. 7, in addition to functional components of the storage system 1 illustrated in FIG. 5, the CPU 11 includes a load confirmation unit 115 and a redundancy determination unit 116.

The load confirmation unit 115 confirms whether a load of I/O is high, that is, a load of a normal IOC 12 which is used for normal operation of the storage system 1 is high. For example, the load confirmation unit 115 confirms whether the load of I/O is high based on whether the load exceeds a predetermined threshold value.

The redundancy determination unit 116 determines whether a predetermined number or more of phys in the normal IOC 12 is used, that is, the number of phys in the normal IOC 12 which are not separated is a predetermined number or larger (for example, two).

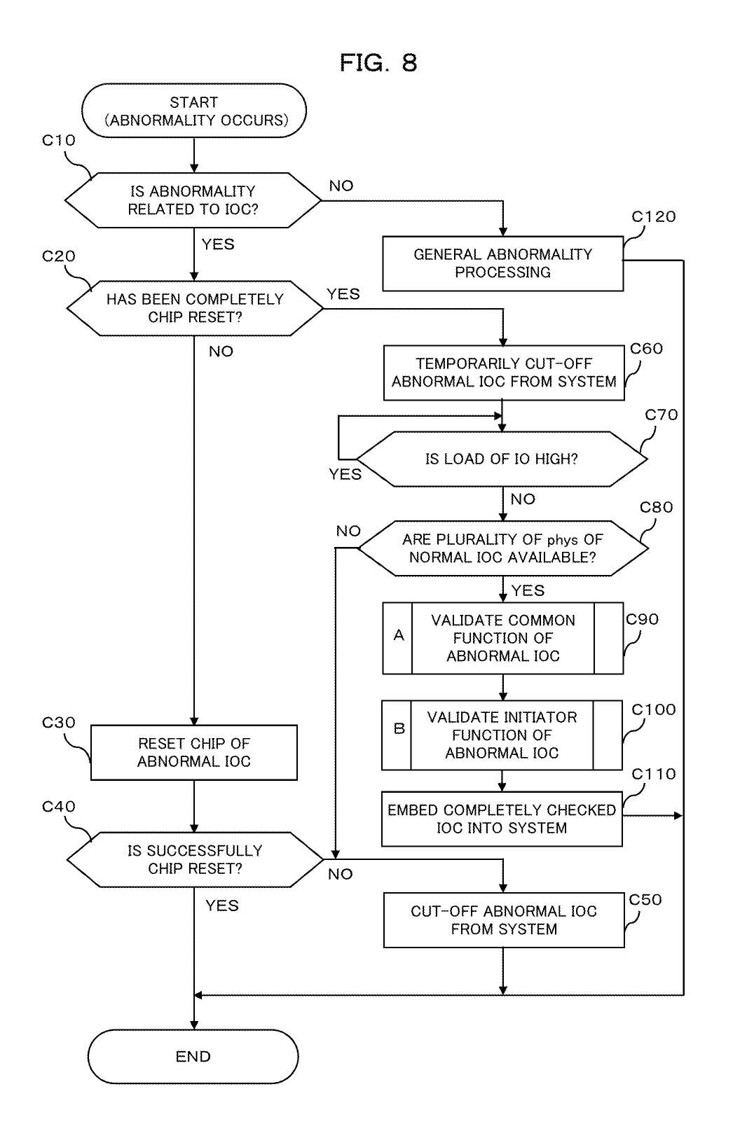

The abnormality diagnosis processing in the storage system 1 as the second modification example of the embodiment configured as described above will be descried with reference to the flowchart illustrated in FIG. 8 (steps C10 to C120).

When abnormality occurs in the storage system 1, the confirmation unit 111 confirms whether the generated abnormality is related with the IOC 12 (step C10). For example, the determination is implemented by determining which one of the abnormalities (1) to (4) of the IOC indicates the abnormality, referring to an error log.

When the generated abnormality is related with the IOC 12 (see Yes route of step C10), the reset processing unit 114 determines whether the chip of the IOC 12 in which the abnormality is generated has been reset in the past (step C20).

When the chip of the IOC 12 in which the abnormality is generated has not been reset in the past (No route of step C20), the reset processing unit 114 resets the chip of the IOC 12 in which the abnormality is generated (step C30).

The reset processing unit 114 determines whether the chip was successfully reset, that is, whether the IOC 12 in which the abnormality is generated is restarted (step C40).

When the chip was successfully reset (see Yes route of step C40), the abnormality diagnosis processing in the storage system 1 is completed.

In contrast, when the chip was not successfully reset (see No route of step C40), the cut-off processing unit 112 separates the IOC 12 in which the abnormality is generated from the storage system 1 (step C50) and completes the abnormality diagnosis processing in the storage system 1.

Further, when the chip of the IOC 12 in which the abnormality is generated has been reset in the past (see Yes route of step C20), the cut-off processing unit 112 temporarily separates the IOC 12 in which the abnormality is generated from the storage system 1 (step C60).

The load confirmation unit 115 confirms whether the load of I/O is high (step C70).

When the load of I/O is not high (see No route of step C70), the redundancy determination unit 116 confirms whether a plurality of phys in the normal IOC 12 can be used (step C80).

When the plurality of phys of the normal IOC 12 can be used (see Yes route of step C80), the validation unit 113 performs the validation processing A (see steps A30 to A70 of FIG. 3) of the common function of the abnormal IOC (step C90).

By doing this, only when the phys of the normal IOC 12 is redundant, the validation processing A of the common function of the abnormal IOC and the validation processing B of the initiator function of the abnormal IOC may be performed.

The validation unit 113 performs the validation processing B (see steps A80 to A120 of FIG. 4) of the initiator function of the abnormal IOC (step C100).

The cut-off processing unit 112 releases the temporary separation of the abnormal IOC 12 to be returned to the abnormal IOC 12 to the storage system 1 (step C110) and completes the abnormality diagnosis processing in the storage system 1. Further, when all phys of the abnormal IOC 12 are separated, the cut-off processing unit 112 does not release the temporal separation of the abnormal IOC 12.

Further, when the plurality of phys of the normal IOC 12 cannot be used (see No route of step C80), the processing proceeds to step C50.

In contrast, when the load of I/O is high (see Yes route of step C70), the load confirmation unit 115 returns to step C70 in order to be in a standby status until the load of I/O is lowered.

By doing this, the validation processing A of the common function of the abnormal IOC and the validation processing B of the initiator function of the abnormal IOC are not performed until the load of I/O is lowered.

In the meantime, when the generated abnormality is not related with the IOC 12 (for example, the storage device 30 or the phy 50c is abnormal) (See No route of step C10), the CPU 11 or an operator performs the generally abnormality processing by an existing method (step C120) and then abnormality diagnosis processing in the storage system 1 is completed.

In the second modification example of the embodiment, any one of the step C70 and step C80 may not be performed.

Further, in step C70, in case the load of I/O is not lowered even when a predetermined time has elapsed, the processing proceeds to step C50 and the cut-off processing unit 112 separates the abnormal IOC 12 from the storage system 1.

As described above, according to the storage system 1 as the second modification example of the embodiment, the same operation and effect as the example of the embodiment described above may be obtained and the following effect may be also achieved.

The load confirmation unit 115 confirms the load of I/O and when the load of I/O is not high, the validation unit 113 validates the abnormal portion, which may not interrupt the task.

Further, the redundancy determination unit 116 determines the redundancy of the phy. When the phy is redundant, the validation unit 113 validates the abnormal portion so that reliability may be improved.

### [B-3] Others

The abnormality diagnosis method of the storage system 1 as the example of the embodiment or the modification examples of the embodiment described above may be achieved not only during the normal operation of the storage system 1, but also during the test of operation confirmation of the IOC 12 in a device manufacturing factory.

Further, the cut-off processing unit 112 may appropriately separate the IOC 12 in which the abnormality is generated by the load of I/O or the number of phys which may be used by the IOC 12 after performing the abnormal diagnosis processing of the IOC 12.

According to the disclosed control system, it is possible to efficiently separate the IOC in which the abnormality is detected from the system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A control system including at least two controllers configured to serve as initiators to control a control target device, the control system comprising:
a confirmation unit configured to operate one of the two controllers as an initiator and the other controller as a target to confirm statuses of the two controllers; and
a validation unit configured to operate an abnormal controller which is confirmed by the confirmation unit as a target and a normal controller as an initiator and performs a data access process on the target to validate a function of the abnormal controller.

2. The control system according to claim 1, wherein after performing the validation to validate a common function of the initiator and the target of the abnormal controller, the validation unit operates the abnormal controller as an initiator and the normal controller as a target, performs the data access process on the target, and validates a function of the initiator of the abnormal controller.

3. The control system according to claim 1, further comprising:
a reset processing unit configured to reset the abnormal controller,
wherein the validation unit validates the function after confirming that the reset processing unit resets the abnormal controller.

4. The control system according to claim 1, further comprising:
a load confirmation unit configured to confirm a load situation in the control system,
wherein when the load confirmation unit confirms that a load of the control system is low, the validation unit validates the function.

5. The control system according to claim 1,
wherein the two controllers are connected through a plurality of redundant communication pathways, and
the validation unit sequentially performs the data access process on the target through one communication pathway selected from among the plurality of communication pathways to validate the function.

6. The control system according to claim 5, further comprising:
a redundancy determination unit configured to confirm whether at least two communication pathways among the plurality of communication pathways are effective,
wherein when the redundancy determination unit confirms that the at least two communication pathways are effective, the validation unit validates the function.

7. An abnormality diagnosis method of a control system including at least two controllers configured to serve as initiators to control a control target device, the method comprising:
operating one of the two controllers as an initiator and the other controller as a target to confirm statuses of the two controllers; and
operating an abnormal controller as a target and a normal controller as an initiator and performing a data access process on the target to validate a function of the abnormal controller.

8. The abnormality diagnosis method according to claim 7, further comprising:
after performing the validation to validate a common function of the initiator and the target of the abnormal controller,
operating the abnormal controller as an initiator and the normal controller as a target and performing the data access process on the target to validate a function of the initiator of the abnormal controller.

9. The abnormality diagnosis method according to claim 7, further comprising:
resetting the abnormal controller,
wherein the function is validated after confirming that the abnormal controller is reset.

10. The abnormality diagnosis method according to claim 7, further comprising:
confirming a load situation in the control system,
wherein when it is confirmed that a load of the control system is low, the function is validated.

11. The abnormality diagnosis method according to claim 7, wherein the two controllers are connected through a plurality of redundant communication pathways, and the data access process is sequentially performed on the target through one communication pathway selected from among the plurality of communication pathways to validate the function.

12. The abnormality diagnosis method according to claim 11, further comprising:
confirming whether at least two communication pathways of the plurality of communication pathways are effective,
wherein when it is confirmed that the at least two communication pathways are effective, the function is validated.

13. A computer-readable recording medium having stored therein a program for causing a computer to execute a process for performing abnormality diagnosis of the control system including at least two controllers configured to serve as initiators to control a control target device, the process comprising:
operating one of the two controllers as an initiator and the other controller as a target to confirm statuses of the two controllers; and
operating an abnormal controller as a target and a normal controller as an initiator and performing a data access process on the target to validate a function of the abnormal controller.

14. The computer-readable recording medium according to claim 13, the process further comprising:
after performing the validation to validate a common function of the initiator and the target of the abnormal controller,
operating the abnormal controller as an initiator and the normal controller as a target and performing the data access process on the target to validate a function of the initiator of the abnormal controller.

15. The computer-readable recording medium according to claim 13, the process further comprising:
resetting the abnormality controller, and
validating the function after confirming that the abnormal controller is reset in the resetting the abnormality controller.

16. The computer-readable recording medium according to claim 13, the process further comprising:
confirming a load situation in the control system; and
validating the function when it is confirmed that the load of the control system is low.

17. The computer-readable recording medium according to claim 13, the process further comprising:
validating the function by sequentially performing a data access process on the target through one communication pathway selected from among a plurality of redundancy communication pathways that connect the two controllers.

18. The computer-readable recording medium according to claim 17, the process further comprising:
confirming whether at least two communication pathways of the plurality of communication pathways are effective,
wherein when it is confirmed that the at least two communication pathways are effective, the function is validated.
